(19) United States
(12) Patent Application Publication
(10) Pub. No.: US 2020/0158822 A1
(43) Pub. Date: May 21, 2020

(54) UNMANNED AERIAL VEHICLE RADAR DETECTION

(71) Applicant: Airspace Systems, Inc., San Leandro, CA (US)

(72) Inventors: Trevor L. Owens, San Francisco, CA (US); Guy Bar-Nahum, Sausalito, CA (US)

(21) Appl. No.: 16/123,967

(22) Filed: Sep. 6, 2018

(51) Int. Cl. G01S 7/41; H01Q 1/28; F41H 11/02; B64C 39/02

(52) U.S. Cl. CPC G01S 7/415; H01Q 1/28; B64C 2201/141; F41H 11/02; B64C 39/024; G01S 7/417

(57) ABSTRACT

An aerial vehicle system comprises a radar system and a processor. The radar system is configured to transmit a radar signal. The transmitted radar signal is reflected off an object to produce a reflected radar signal. The radar system is configured to receive the reflected radar signal and provide a signature associated with the reflected radar signal. The signature has been adjusted based at least in part on a flight parameter of the aerial vehicle system. The processor is configured to classify the object as an unmanned aerial vehicle based on the adjusted signature and initiate an action based on a classification of the object.

### BACKGROUND OF THE INVENTION

Unmanned Aerial Platforms, including Unmanned Aerial Vehicles (UAV) and Aerial Drones, may be used for a variety of applications. However, some applications may pose a risk to people or property. UAVs have been used to carry contraband, including drugs, weapons, and counterfeit goods across international borders. It is further possible that UAVs may be used for voyeuristic or industrial surveillance, to commit terrorist acts such as spreading toxins, or to transport an explosive device. In view of this risk posed by malicious UAVs, it may be necessary to have a system to intercept, capture, and transport away a UAV that has entered a restricted area.

### BRIEF DESCRIPTION OF THE DRAWINGS

Various embodiments of the invention are disclosed in the following detailed description and the accompanying drawings.

FIG. 1 is a block diagram illustrating an embodiment of a UAV.

FIG. 2 is a diagram illustrating an embodiment of an antenna array for a radar system.

FIG. 3A is a diagram illustrating an embodiment of an antenna array for a radar system.

FIG. 3B is a diagram illustrating an embodiment of an antenna array for a radar system.

FIG. 3C is a diagram illustrating an embodiment of an antenna element.

FIG. 4 is a diagram illustrating an embodiment of a velocity profile.

FIG. 5 is a flow chart illustrating an embodiment of a process for capturing a target UAV.

FIG. 6 is a flow chart illustrating an embodiment of a process for determining a micro-Doppler signature associated with a detected object.

FIG. 7 is a flow chart illustrating an embodiment of a process for detecting an object.

FIG. 8 is a flow chart illustrating an embodiment of a process for generating a micro-Doppler signature associated with an object.

FIG. 9 is a flow chart illustrating an embodiment of a process for capturing a UAV.

FIG. 10 is a flow chart illustrating an embodiment of a process for classifying an object.

FIG. 11A is a diagram illustrating a front view of a UAV in accordance with some embodiments.

FIG. 11B is a diagram illustrating a side view of a UAV in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Radar is a detection system that uses radio waves to detect objects. A radar system may be comprised of one or more transmitters and one or more receivers. In some embodiments, an antenna element of the radar system may act as both a transmitter and a receiver. The radar system may detect an object by transmitting radio waves in the direction of an object. The object may reflect a portion of the transmitted radio wave back to the radar system. The amplitude of the reflected wave depends on the material of the object and the distance between the radar system and the object. A first portion of the transmitted wave may be absorbed by the object and a second portion of the transmitted wave may be reflected. The reflected portion of the transmitted wave may be detected by the one or more receivers of the radar system. The distance between the radar system and the object may be determined based on a time of flight or a frequency modulation between the transmitted wave and the reflected wave.

One type of antenna design used for radar systems is a phased array. A phased array is comprised of a plurality of evenly spaced antenna elements. Each antenna element may act as both a transmitting antenna and a receiving antenna. Each antenna element has an associated phase shifter. A beam may be formed by shifting the phase of the signal emitted from each antenna element, such that signals at particular angles experience constructive interference while others experience destructive interference. To change the directionality of the phased array when transmitting, a beam former may control the phase and relative amplitude of the signal at each antenna element, in order to create a pattern of construction and destructive interference in the wave front. The phased array may also generate a plane wave by transmitting waves that are in phase.

One problem with a phased antenna array is spatial aliasing. Spatial aliasing occurs when there is insufficient sampling of a reflection wave along the antenna array. This may occur when the spacing between the antenna elements is not smaller than half the wavelength of the reflection wave. To prevent spatial aliasing, the reflection wave should be sampled at least more than two times per the wavelength of the reflection wave. When the antenna elements of the phased antenna array are not spaced apart less than half the wavelength of the reflection wave, an antenna element of the phased antenna array may return an artifact (e.g., false positive) and indicate that it detected an object.

An unmanned aerial vehicle (UAV) (e.g., drone) is an aircraft without a human pilot aboard the vehicle. The UAV may be remotely controlled by a human operator or autonomously controlled by on-board computers. The UAV may be equipped with a radar system to detect one or more objects. For some UAVs, the size of a UAV radar system needs be small and low powered due to size, weight, and power concerns. The spacing between antenna elements of the UAV radar system may be 1 mm. As a result, the UAV radar system may be susceptible to spatial aliasing when detecting objects.

UAVs are typically used to perform various tasks, such as surveillance, aerial photography, product deliveries, racing, etc. UAVs have become ubiquitous. Unintended uses for UAVs have emerged. For example, UAVs have been used to carry contraband, including drugs, weapons, and counterfeit goods across international borders. It is further possible that UAVs may be used for voyeuristic or industrial surveillance, to commit terrorist acts such as spreading toxins, or to transport an explosive device. Conventional techniques to disable a UAV include shooting down the UAV from the ground. However, such a technique risks bodily harm and/or property damage when the UAV crashes.

A target UAV may be captured and/or disabled by a defending UAV. A defending UAV may include an interdiction system to automatically capture the target UAV when the defending UAV is flying near the target UAV. The interdiction system may be comprised of a capture net launcher, an interdiction sensor package, and an interdiction control system. When a net is launched and captures a target UAV, the target UAV may remain tethered to the defending UAV via a rope. This enables the defending UAV to transport the target UAV to a safe location. Accurately identifying and locating a target UAV is important because the number of nets associated with the capture net launcher may be limited and finite due to the size of the defending UAV. Accidentally deploying the capture net launcher to capture an object that is not a UAV (e.g., bird, balloon) reduces the number of nets that may be used to capture actual target UAVs.

A target UAV may be detected by using a radar system that is comprised of a phased antenna array. The radar system may be configured to perform a three dimensional scan. A three dimensional scan may be carried out by performing a two dimensional multiple-in multiple-out (MIMO) scan. Each antenna element of the phased antenna array may together transmit a corresponding signal to detect one or more objects. The transmission signal may reflect off one or more objects and the reflection signal(s) be received at a subset of the antenna elements. The combination of received reflection signals may be used to determine a range, azimuth angle, and elevation angle of the detected object.

As discussed above, the phase antenna array may be susceptible to spatial aliasing due to its physical layout. To counteract spatial aliasing, each of the antenna elements of the subset of antenna elements may individually transmit a corresponding signal to detect one or more objects, i.e., a one dimensional MIMO scan. The phased antenna array has enough density to avoid spatial aliasing. The one dimensional MIMO scan provides two dimensions of information (range, azimuth angle). Each antenna element of the phased antenna array may individually transmit a corresponding signal to detect one or more objects. The corresponding transmission signals may reflect off one or more objects and the reflection signal(s) be received at a subset of the antenna elements. The combination of received reflection signals may be used to determine a range and azimuth angle of the detected object. The corresponding transmission signals may reflect off one or more objects and the reflection signal(s) may be received at one or more antenna elements of the subset of antenna elements. The one or more antenna elements of the subset of antenna elements that received a reflection signal are determined to have actually received a reflection signal and the received reflection signal is not an artifact. In some embodiments, a direction of a beam of the phased antenna array is focused towards a detected object such that a plurality of antenna elements receive a reflection signal from the detected object. By switching rapidly between a two dimensional scan and a one-dimensional scan, the radar system is able to determine which detections in the two-dimensional MIMO scan do not appear in the one-dimensional MIMO scan. This allows spurious detections in the azimuthal direction to be discarded. To discard spurious detections in the elevation direction, the centered maximum detection is considered. The centered maximum detection may be among any set of three since two spurious detections will have a lower signal-to-noise ratio and will be symmetric above and below the actual detection.

A reflection signal may be used to determine a range of an object. The range is the distance between an antenna element of the radar system and the object. The range may be determined based of a time of flight needed to transmit a signal to the object and to receive a reflection signal. The range may also be determined by comparing a frequency of the transmitted signal with the frequency of the reflection signal.

The received signals may be used to determine a velocity of an object. The velocity of the object may be determined based on a Doppler shift of the reflected signal with respect to the transmitted signal. A Doppler shift occurs when the source of waves is moving with respect to an observer. For example, when a radar wave is incident on a moving target, the moving target may reflect the radar wave and cause a Doppler shift in the reflection wave.

The frequency of the reflected wave f may be determined by calculating:

$$f = ( \frac{c \pm {v}_{r}}{c \pm {v}_{s}} ) {f}_{0}$$

where f₀ is the frequency of the transmitted wave, c is the velocity of the waves in the medium, vᵣ is the velocity of the receiver relative to the medium; positive if the receiver is moving towards the source (and negative in the other direction), and vₛ is the velocity of the source relative to the medium; positive if the source is moving away from the receiver (and negative in the other direction.

An antenna element of the antenna array may transmit a signal that is reflected off a plurality of objects. The antenna element may receive reflection signals from each of the plurality of objects. The frequency of the reflection signals may be used to determine a velocity associated with each of the plurality of objects. An object may produce a plurality of reflection signals. A transmission signal may be transmitted toward an object and reflect off different components of the object. The reflection signals off the different components may be combined and received at an antenna element. The object may also include a plurality of components moving at different velocities. For example, a transmission signal may be transmitted towards a car. The transmission signal may be reflected by the body of the car and the wheels of the car. The velocity of the body of the car and the wheels of the car is different. A transmission signal may be transmitted towards a UAV. The transmission signal may be reflected by the body of the UAV and each propeller of the UAV. A velocity of the body of the UAV is different than the velocity of the propellers. A velocity of each propeller may also be different.

A defending UAV may include one or more inertial measurement units (IMUs). The measurements from the one or more IMUs may be used to calculate attitude, angular rates, linear velocity, and/or a position relative to a global reference frame. The radar system of the defending UAV may use the measurements from the one or more IMUs to determine an EGO motion of the defending UAV. The radar system may be configured to remove the EGO motion data of the defending UAV from the reflection signal data to determine one or more velocities associated with a detected object. From the defending UAV's perspective, every detected item appears to be moving when the defending UAV is flying. Removing the EGO motion data from the velocity determination allows the radar system to determine which detected objects are static and/or which detected objects are moving. The one or more determined velocities may be used to determine a micro-Doppler signature of an object.

The micro-Doppler signature may be represented as a velocity profile of the reflecting object. The velocity profile compares a velocity of the reflection signal(s) with an amplitude (strength) of the reflection signal(s). The velocity axis of the velocity profile is comprised of a plurality of bins. A velocity of the reflection signal with the highest amplitude may be identified as a reference velocity and the amplitude associated with the reference velocity may be associated with a reference bin (e.g., bin B₀). The one or more other velocities included in the reflection signal may be compared with respect to the reference velocity. Each bin of the velocity profile represents an offset with respect to the reference velocity. A corresponding bin for the one or more other velocities included in the reflection signal may be determined. A determined bin includes an amplitude associated with one of the one or more other velocities included in the reflection signal. For example, a reflection signal may be a reflection signal associated with a UAV. The UAV is comprised of a main body and a plurality of propellers. The velocity of a UAV body may be represented as a reference velocity in the velocity profile. The velocity of a UAV propeller may be represented in a bin offset from the reference velocity. The bin associated with the reference velocity may store an amplitude associated with the velocity of the UAV body. The bin offset from the reference bin may store an amplitude associated the velocity of a UAV propeller.

A direction of a beam of the phased antenna array may be focused towards a detected object such that a plurality of antenna elements receive a reflection signal from the detected object. The plurality of antenna elements that receive a reflection signal may be adjacent to the antenna element that detected the object during the one dimensional MIMO scan. A velocity profile for each of the received corresponding reflection signals may be generated.

The velocity profile for each of the received corresponding reflection signals may be combined with the velocity profile of the antenna element that detected the object during the one dimensional MIMO scan. The combined velocity profile includes the same bins as one of the velocity profile, but a bin of the combined velocity profile stores a plurality of amplitudes from the plurality of velocity profiles. A maximum amplitude value (peak) may be selected for each bin of the combined velocity profile. The maximum amplitude bin values may be used in a feature vector to classify the object. For example, the feature vector may include the values {B₀ₘₐₓ, B₁ₘₐₓ, . . . , Bₙₘₐₓ}.

The feature vector may be applied to a machine learning model that is trained to determine whether the object is a UAV or not a UAV. In the event the machine learning model outputs a value that labels the object as a UAV, the defending UAV may be configured to perform an action, such as activating an interdiction system to capture the object. The combination of 2D MIMO scans, 1D MIMO scans, and micro-Doppler signature classification enables the defending UAV to accurately detect and identify a target UAV. As a result, the defending UAV may capture the target UAV and prevent the target UAV from carrying out criminal acts.

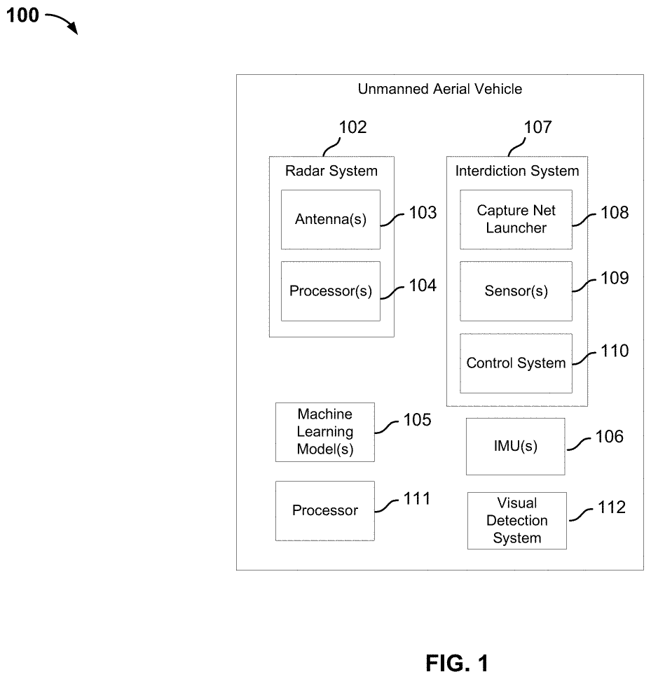

FIG. 1 is a block diagram illustrating an embodiment of a UAV. In the example shown, UAV 100 comprises a radar system 102, one or more IMUs 106, and an interdiction system 107. UAV 100 may include one or more other systems and/or components that are not shown (e.g., propellers, flight control system, landing control system, power system, etc.).

Radar system 102 is comprised of one or more antennas 103 and one or more processors 104.

The one or more antennas 103 may be a phased array, a parabolic reflector, a slotted waveguide, or any other type of antenna design used for radar. The one or more processors 104 are configured to excite a transmission signal for the one or more antennas 103. The transmission signal has a frequency f₀. Depending on the antenna design, the transmission signal may have a frequency between 3 MHz to 110 GHz. In some embodiments, the one or more antennas are configured to operate in a frequency range of 79 MHz to 1 GHz. In response to the excitation signal, the one or more antennas 103 are configured to transmit the signal. The transmission signal may propagate through space. The transmission signal may reflect off one or more objects. The reflection signal may be received by the one or more antennas 103. In some embodiments, the reflection signal is received by a subset of the one or more antennas 103. In other embodiments, the reflection signal is received by all of the one or more antennas 103. The strength (amplitude) of the received signal depends on a plurality of various factors, such as a distance between the one or more antennas 103 and the reflecting object, the medium in which the signal is transmitted, the environment, and the material of the reflecting object, etc.

The one or more processors 104 are configured to receive the reflection signal from the one or more antennas 103. The one or more processors 104 are configured to determine a velocity of the detected object based on the transmission signal and the reflection signal. The velocity may be determined by computing the Doppler shift. A detected object may have one or more associated velocities. An object without any moving parts, such as a balloon, may be associated with a single velocity. An object with moving parts, such as a car, helicopter, UAV, plane, etc., may be associated with more than one velocity. The main body of the object may have an associated velocity. The moving parts of the object may each have an associated velocity. For example, a UAV is comprised of a body portion and a plurality of propellers. The body portion of the UAV may be associated with a first velocity. Each of the propellers may be associated with corresponding velocities.

In some embodiments, the one or more antennas 103 are a phased antenna array. In the event the one or more antennas 103 detect an object, a beam associated with the phase antenna array may be directed towards the object. To change the directionality of the antenna array when transmitting, a beam former (e.g., the one or more processors 104) may control the phase and relative amplitude of the signal at each transmitting antenna of the antenna array, in order to create a pattern of constructive and destructive interference in the wave front.

Radar system 102 is coupled to one or more inertial measurement units 106. The one or more inertial measurement units 106 are configured to calculate attitude, angular rates, linear velocity, and/or a position relative to a global reference frame. The one or more processors 104 may use the measurements from the one or more IMUs 106 to determine an EGO motion of UAV 100. The one or more processors 104 may also use one or more extended Kalman filters to smooth the measurements from the one or more inertial measurement units 106. One or more computer vision-based algorithms (e.g., optical flow) may be used to determine the EGO motion of UAV 100. The one or more processors 104 may be configured to remove the EGO motion data of UAV 100 from the reflection signal data to determine one or more velocities associated with a detected object. From UAV 100's perspective, every detected item appears to be moving when UAV 100 is flying. Removing the EGO motion data from the velocity determination allows radar system 102 to determine which detected objects are static and/or which detected objects are moving. The one or more determined velocities may be used to determine a micro-Doppler signature of an object.

The one or more processors 104 may generate a velocity profile from the reflected signal to determine a micro-Doppler signature associated with the detected object. The velocity profile compares a velocity of the reflection signal(s) with an amplitude (strength) of the reflection signal(s). The velocity axis of the velocity profile is comprised of a plurality of bins. A velocity of the reflection signal with the highest amplitude may be identified as a reference velocity and the amplitude associated with the reference velocity may be associated with a reference bin (e.g., bin B₀). The one or more other velocities included in the reflection signal may be compared with respect to the reference velocity. Each bin of the velocity profile represents an offset with respect to the reference velocity. A corresponding bin for the one or more other velocities included in the reflection signal may be determined. A determined bin includes an amplitude associated with one of the one or more other velocities included in the reflection signal. For example, a reflection signal may be a reflection signal associated with a UAV. The UAV is comprised of a main body and a plurality of propellers. The velocity of a UAV body may be represented as a reference velocity in the velocity profile. The velocity of a UAV propeller may be represented in a bin offset from the reference velocity. The bin associated with the reference velocity may store an amplitude associated with the velocity of the UAV body. The bin offset from the reference bin may store an amplitude associated the velocity of a UAV propeller.

A direction of a beam of the phased antenna array may be focused towards a detected object such that a plurality of antenna elements 103 receive a reflection signal from the detected object. The plurality of antenna elements that receive a reflection signal may be adjacent to the antenna element that detected the object during the one dimensional MIMO scan. A velocity profile for each of the received corresponding reflection signals may be generated.

The velocity profile for each of the received corresponding reflection signals may be combined with the velocity profile of the antenna element that detected the object during the one dimensional MIMO scan. The combined velocity profile includes the same bins as one of the velocity profile, but a bin of the combined velocity profile stores a plurality of amplitudes from the plurality of velocity profiles. A maximum amplitude value (peak) may be selected for each bin of the combined velocity profile. The maximum amplitude bin values may be used in a feature vector to classify the object. For example, the feature vector may include the values {B₀ₘₐₓ, B₁ₘₐₓ, . . . , Bₙₘₐₓ}.

Radar system 102 is coupled to processor 111. Radar system 102 may provide the feature vector to processor 111 and the processor 111 may apply the feature vector to one of the machine learning models 105 that is trained to determine whether the object is a UAV or not a UAV. The one or more machine learning models 105 may be trained to label one or more objects. For example, a machine learning model may be trained to label an object as a “UAV” or “not a UAV.” A machine learning model may be trained to label an object as a “bird” or “not a bird.” A machine learning model may be trained to label an object as a “balloon” or “not a balloon.”

The one or more machine learning models 105 may be configured to implement one or more machine learning algorithms (e.g., support vector machine, soft max classifier, autoencoders, naïve bayes, logistic regression, decision trees, random forest, neural network, deep learning, nearest neighbor, etc.). The one or more machine learning models 105 may be trained using a set of training data. The set of training data includes a set of positive examples and a set of negative examples. For example, the set of positive examples may include a plurality of feature vectors that indicate the detected object is a UAV. The set of negative examples may include a plurality of feature vectors that indicate the detected object is not a UAV. For example, the set of negative examples may include feature vectors associated with a balloon, bird, plane, helicopter, etc.

In some embodiments, the output of machine learning model trained to identify UAVs may be provided to one or more other machine learning model that are trained to identify specific UAV models. The velocity profile of a UAV may follow a general micro-Doppler signature, but within the general micro-Doppler signature, different types of UAVs may be associated with different micro-Doppler signatures. For example, the offset difference between a bin corresponding to a baseline velocity and a bin corresponding to a secondary velocity may have a first value for a first UAV and a second value for a second UAV.

Processor 111 may provide the output from the one or more machine learning models 105 to interdiction system 107. Interdiction system 107 includes a capture net launcher 108, one or more sensors 109, and a control system 110. The control system 110 may be configured to monitor signals received from the one or more sensors 109 and/or radar system 102, and control the capture net launcher 108 to automatically deploy the capture net when predefined firing conditions are met. One of the predefined firing conditions may include an identification of a target UAV. One of the predefined firing conditions may include a threshold range between the target UAV and UAV 100. The one or more sensors 109 may include a global positioning system, a light detection and ranging (LIDAR) system, a sounded navigation and ranging (SONAR) system, an image detection system (e.g., photo capture, video capture, UV capture, IR capture, etc.), sound detectors, one or more rangefinders, etc. For example, eight LIDAR or RADAR beams may be used in the rangefinder to detect proximity to the target UAV. The one or more sensors 109 may include image capture sensors which may be controlled by the interdiction control system 110 to capture images of the object when detected by the range finding sensors. Based on the captured image and the range readings from the ranging sensors, the interdiction system may identify whether or not the object is the target UAV that is identified by radar system 102.

When the interdiction control system 110 determines that the object is a target UAV, it may also determine if the target UAV is an optimal capture position relative to the defending UAV. If the relative position between the target UAV and the defending UAV is not optimal, interdiction control system 110 may provide a recommendation or indication to the remote controller of the UAV. Interdiction control system 1110 may provide or suggest course corrections directly to the processor 111 to maneuver the UAV into an ideal interception position autonomously or semi-autonomously. Once the ideal relative position between the target UAV and the defending UAV is achieved, interdiction control system 110 may automatically trigger capture net launcher 108. Once triggered, capture net launcher 108 may fire a net designed to ensnare the target UAV and disable its further flight.

The net fired by the capture net launcher may include a tether connected to UAV 100 to allow UAV 100 to move the target UAV to a safe area for further investigation and/or neutralization. The tether may be connected to the defending UAV by a retractable servo controlled by the control system 110 such that the tether may be released based on a control signal from the control system 110. Control system 110 may be configured to sense the weight, mass, or inertia effect of a target UAV being tethered in the capture net and recommend action to prevent the tethered target UAV from causing UAV 100 to crash or lose maneuverability. For example, control system 110 may recommend UAV 100 to land, release the tether, or increase thrust. Control system 110 may provide a control signal to the UAV control system (e.g., processor 111) to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

Unmanned Aerial Vehicle 100 may include a camera system 112. Camera system 112 may be used to visually detect a UAV. Camera system 112 may visually detect an object and provide visual data (e.g., pixel data) to one of the one or more machine learning models 105. A machine learning model may be trained to label an object as “a UAV” or “not a UAV” based on the visual data. For example, a set of positive examples (e.g., images of UAVs) and a set of negative examples (e.g., images of other objects) may be used to train the machine learning model. Processor 111 may use the output from the machine learning model trained to label an object as a UAV based on the radar data and the machine learning model trained to label the object as a UAV based on visual data to determine whether active the interdiction system 107. Processor 111 may activate interdiction system 107 in the event the machine learning model trained to label an object as a UAV based on radar data and the machine learning model trained to label the object as a UAV based on visual data indicate that the object is a UAV.

UAV 100 may use radar system 102 to detect an object that is greater than a threshold distance away. UAV 100 may use camera system 112 to detect an object that is less than or equal to the threshold distance away. UAV 100 may use both radar system 102 and camera system 112 to confirm that a detected object is actually a UAV. This reduces the number of false positives and ensures that the capture active mechanism is activated for actual UAVs.

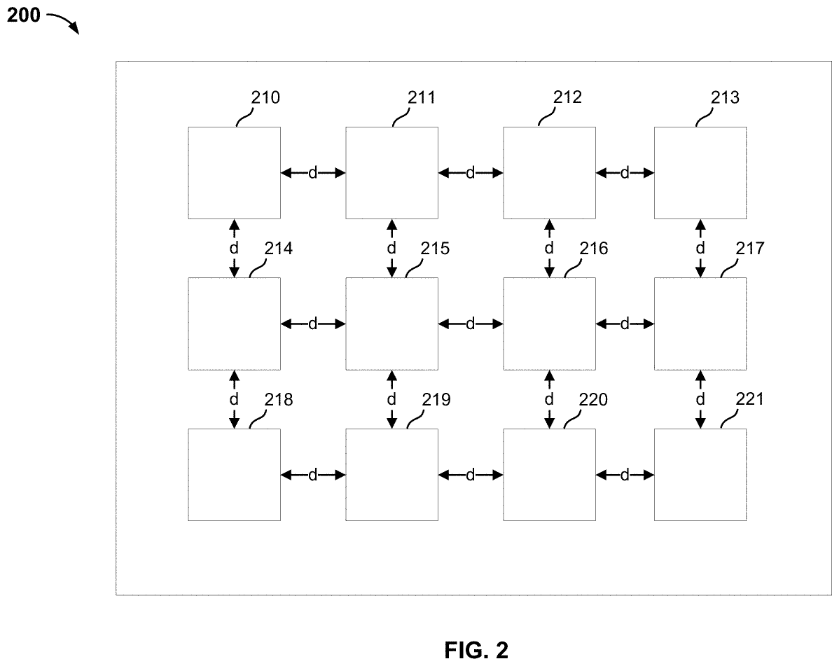

FIG. 2 is a diagram illustrating an embodiment of an antenna array for a radar system. In the example shown, antenna array 200 may implemented by a radar system, such as radar system 102.

Antenna array 200 includes antenna elements 210, 211, 212, 213, 214, 215, 216, 217, 218, 219, 220, 221. Each of the antenna elements is separated by a distance d. In some embodiments, d is approximately 1 mm (e.g., 1 mm±0.1 mm).

Antenna array 200 may be a phased array. Each of the antenna elements 210, 211, 212, 213, 214, 215, 216, 217, 218, 219, 220, 221 may have an associated phase shifter (not shown). A beam may be formed by shifting the phase of the signal emitted from each antenna element, such that signals at particular angles experience constructive interference while others experience destructive interference. For example, the one or more processors 104 of radar system 102 may excite the antenna elements 210, 211, 212, 213, 214, 215, 216, 217, 218, 219, 220, 221 such that the transmitted signals are out of phase. To change the directionality of the phased array when transmitting, a beam former, such as the one or more processors 104 of radar system 102 may control the phase and relative amplitude of the signal at each antenna element, in order to create a pattern of construction and destructive interference in the wavefront. In other embodiments, antenna array 200 may generate a plane wave. For example, the one or more processors 104 of radar system 102 may generate a plane wave by exciting the antenna elements such that the transmitted signals are in phase.

One problem with antenna array 200 is spatial aliasing. Spatial aliasing occurs when there is insufficient sampling of the reflection waves along the antenna array. This may occur when the spacing between the antenna elements d is not smaller than half the wavelength of the reflection wave. To prevent spatial aliasing, the reflection wave should be sampled at least more than two times per the wavelength of the reflection wave. When the antenna elements of the phased antenna array are not spaced apart smaller than half the wavelength of the reflection wave, an antenna element of the phased antenna array may return an artifact (e.g., false positive) and indicate that it detected an object.

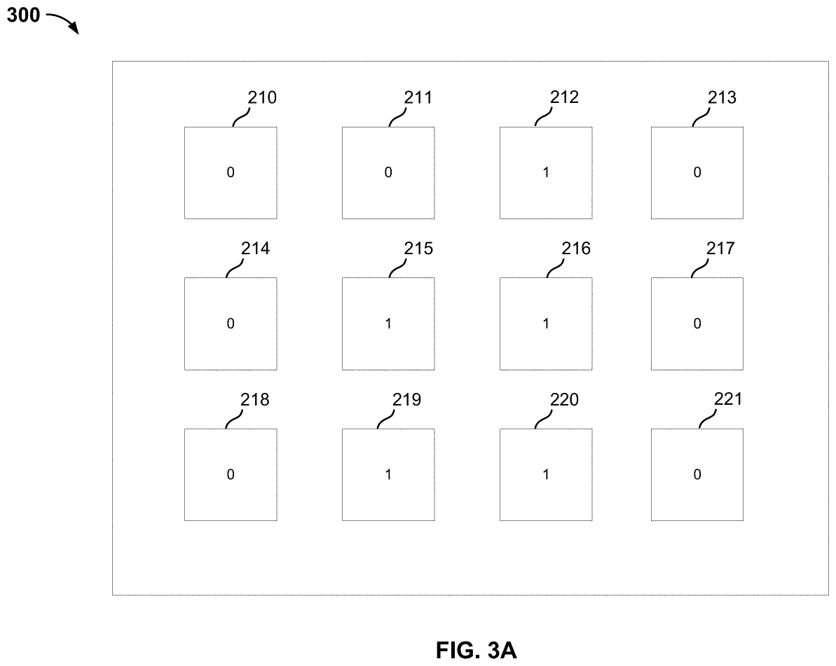

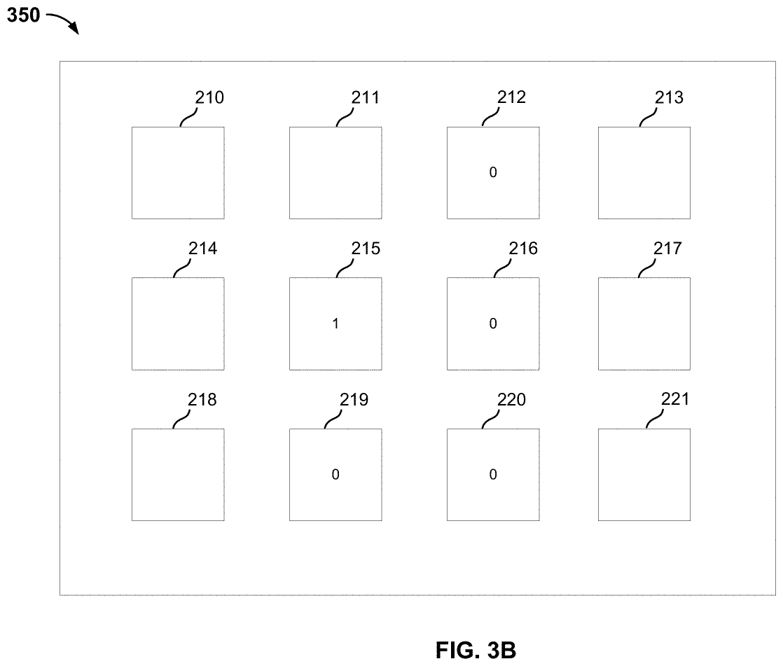

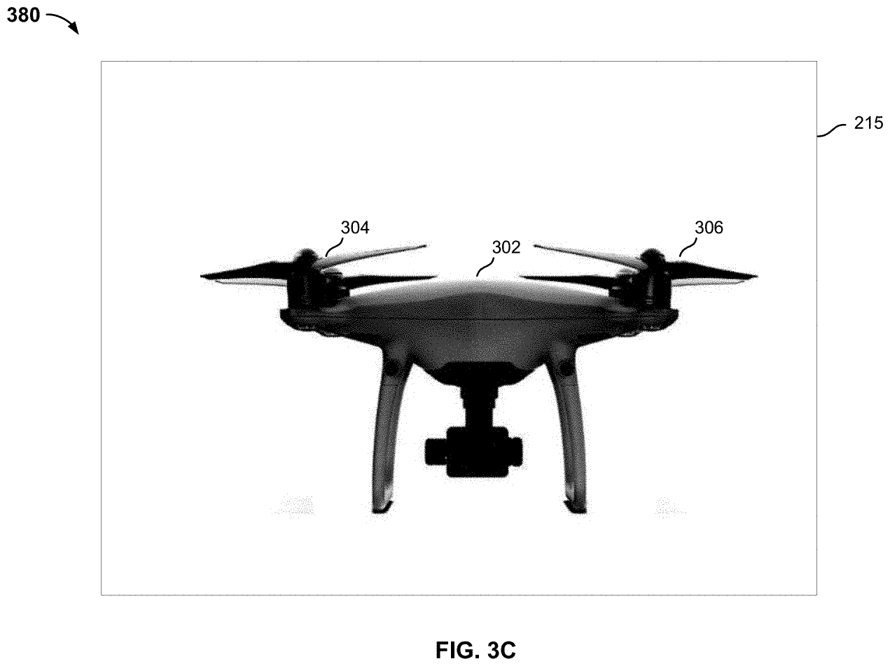

FIG. 3A is a diagram illustrating an embodiment of an antenna array for a radar system. Antenna array 300 may be implemented by a radar antenna, such as the one or more antennas 103.

In the example shown, a 2D MIMO scan was performed by exciting each of the antenna elements 210, 211, 212, 213, 214, 215, 216, 217, 218, 219, 220, 221 such that they concurrently transmit a corresponding signal to detect one or more objects. The 2D MIMO scan may provide three dimensions of information associated with an object (e.g., range, azimuth angle, elevation angle). In some embodiments, an antenna element acts as a transmitting antenna and a receiving antenna. Each of the antenna elements 210, 211, 212, 213, 214, 215, 216, 217, 218, 219, 220, 221 is associated with a “0” or “1” value. A “0” value indicates that an antenna element transmitted a signal, but the antenna element did not receive a reflection signal. In some embodiments, a “1” value indicates that an antenna element transmitted a signal, the signal reflected off an object, and the reflected signal is received at the antenna element. In some embodiments, a “1” value indicates that the antenna element transmitted a signal, the antenna element detected a signal, but the detected signal is an artifact due to spatial aliasing. In the example shown, antenna elements 212, 215, 216, 219, 220 detected a signal.

FIG. 3B is a diagram illustrating an embodiment of an antenna array for a radar system. Antenna array 350 may be implemented by a radar antenna, such as the one or more antennas 103.

In the example shown, a 1D MIMO scan was performed by individually exciting antenna elements 212, 215, 216, 219, 220 such that they transmit a corresponding signal to detect one or more objects. For example, antenna element 212 may be first excited to determine if it detects an object, then antenna element 215 to determine if it detects an object, then antenna element 216 to determine if it detects an object, and so forth. Antenna elements 212, 215, 216, 219, 220 are individually excited because those are the antenna elements that detected an object when a 2D MIMO scan was performed. The antenna elements 212, 215, 216, 219, 220 are individually excited to determine if the antenna elements actually detected object or detected an artifact due to spatial aliasing. The 1D MIMO scan may provide two dimensions of information associated with an object (e.g., range, azimuth angle).

A “0” value indicates that an antenna element transmitted a signal, but the signal was not reflected off an object. In the event an antenna element outputs a “1” value after a 2D MIMO scan and outputs a “0” value after a 1D MIMO scan, the “1” value associated with the 2D MIMO scan is determined to be an artifact. In the event an antenna element outputs a “1” value after a 2D MIMO scan and outputs a “1” value after a 1D MIMO scan, a “1” value indicates that an antenna element transmitted a signal, the signal reflected off an object, and the antenna element actually detected the reflected signal.

FIG. 3C is a diagram illustrating an embodiment of an antenna element. In the example shown, antenna element 215 detected an object. An antenna element may detect various types of objects, such as a balloon, a bird, a plane, a UAV, a helicopter, a building, a car, people, etc. In the example shown, antenna element 215 has detected a UAV. The detected UAV includes a body portion 302, a first propeller 304, and a second propeller 306.

Antenna element 215 may transmit a signal to detect one or more objects. The transmitted signal may be reflected by an object and the reflected signal may be received by antenna element 215. In some embodiments, the detected object is a moving object. The frequency of the reflection signal may be used to determine a velocity associated with the detected object. In some embodiments, the detected object is comprised of a plurality of components. The detected object may include one or more components that do not move in unison with a main portion of the detected object. For example, the detected UAV includes a main body portion 302, a first propeller 304, and a second propeller 306. The first propeller 304 has a different velocity than the main body portion 302 and the second propeller 306 also has a different velocity than the main body portion 302. In some embodiments, the first propeller 304 and the second propeller 306 have the same velocity. In other embodiments, the first propeller 304 and the second propeller 306 have different velocities.

Antenna element 215 may detect the signals that are reflected off the first propeller 304, the second propeller 306, and the main body portion 302. The signal transmitted from antenna 215 has an associated transmission frequency. Because the detected UAV is moving, the reflected signals will have a different frequency than the transmission signal. The reflected signal associated with the main body portion 302 will have a first frequency, the reflected signal associated with the first propeller 304 will have a second frequency, and the reflected signal associated with the second propeller 306 will have a third frequency. The reflected signals associated with the main body portion 203, the first propeller 304, and the second propeller 306 may interfere to generate a single reflected signal. The combined reflected signal is detected by antenna element 215 and may be used to generate a micro-Doppler signature of the UAV.

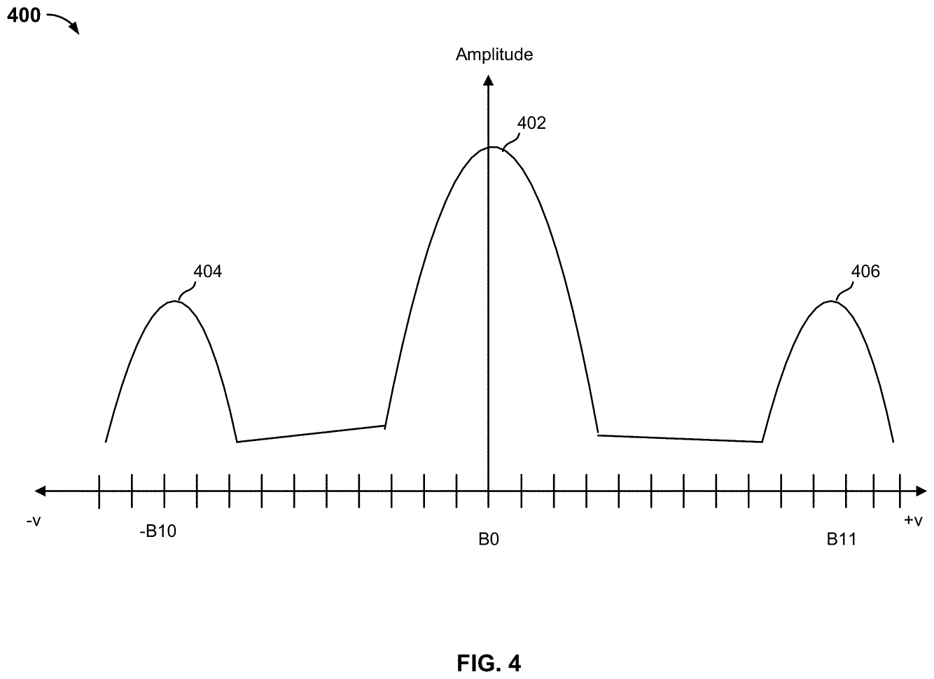

FIG. 4 is a diagram illustrating an embodiment of a velocity profile. In the example shown, velocity profile 400 may be generated by a radar system, such as radar system 102.

An antenna element, such as one of the antenna elements 210, 211, 212, 213, 214, 215, 216, 217, 218, 219, 220, 221, may receive a reflection signal that is reflected off a moving object. The moving object may also be comprised of one or moving parts (e.g., wheels, propeller, wings, etc.). An antenna element may transmit a signal towards an object and the object may reflect the signal at multiple locations. For example, the transmitted signal may be reflected off the main body of the object and each of the one or more moving parts.

When the signal is reflected at multiple locations, the multiple reflections produce multiple reflection signals. The multiple reflection signals may interfere with each other and a combined signal may be received at an antenna element. Each reflected signal has an associated frequency. The associated frequency depends on a velocity of the reflecting surface. For example, a frequency of a signal that reflected off the main body of a moving object depends on a velocity of the main body of the moving object. A frequency of a signal that reflected off a moving component of the moving object (e.g., wheels, propeller, wings, etc.) depends on the velocity of the moving component and the velocity of the moving object.

The combined signal may be received by an antenna element and a velocity profile may be generated based on the combined signal. One or more processors may process the combined signal to detect an amplitude of each of the reflected signals included in the combined signal and a velocity of each of the reflected signals. The reflected signal of the combined signal with the highest amplitude is used as reference velocity. For example, the reflected signal associated with peak 402 is used as a reference velocity. The reference velocity may be associated with a reference bin, for example, bin B₀. In some embodiments, the reflected signal with the highest amplitude is associated with a main body of a reflecting object. In some embodiments, the reflected signal with the highest amplitude is associated with a moving portion of a reflecting object.

The corresponding velocities and corresponding amplitudes associated with the other reflected signals of the combined signal may be determined. A velocity and amplitude associated with one of the other reflected signals of the combined signal may be associated with a bin that is offset from the reference bin B₀. For example, peak 404 is associated with a bin −B₁₀ and peak 406 is associated with bin B₁₁. Peak 404 may be associated with a first moving component of the detected object and peak 406 may be associated with a second moving component of the detected object. Each bin is associated with a velocity offset. The reference bin B₀ is associated with the velocity of the reflection signal having the highest amplitude. Bin B₁ and Bin −B₁ are associated with velocities that are offset from the reference velocity by +v₁ and −v₁, respectively. Bin B₂ and Bin −B₂ are associated with velocities that are offset from the reference velocity by +v₂ and −v₂, respectively. Bin Bₙ and Bin −Bₙ are associated with velocities that are offset from the reference velocity by +vₙ and −vₙ, respectively.

The velocity profile represents a micro-Doppler signature of an object. The velocity profile may be used to classify the object. For example, the velocity profile of a floating balloon is different from the velocity profile of a bird, which is different from the velocity profile of a UAV, which is different from the velocity profile an airplane. That is, a floating balloon will have peaks in different bins than a bird. A bird will have peaks in different bins than a UAV, and a UAV will have peaks in different bins than an airplane. Different UAVs may have similar velocity profiles, but differences within the similar velocity profiles may be used to classify each of the different UAVs such that the different UAVs may be distinguished from each other.

In some embodiments, an object may be detected by a plurality of antenna elements, that is, a plurality of antenna elements receive a reflection signal or a portion of the reflection signal associated with the object. In some embodiments, a beam may be focused on a detected object such that a plurality of antenna elements receive a reflection signal or a portion of the reflection signal associated with the object. A velocity profile for the object may be generated for each of the detecting antenna elements. A velocity profile is comprised of a plurality of bins. Each bin stores an amplitude value for the reflected signal. The bin values for a bin across the plurality of velocity profiles may be combined and a peak bin value may be selected to represent the bin. For example, a velocity profile may be generated for antenna elements 211, 212, 213, 215, 216, 217, 219, 220, 221. Each of the velocity profiles includes a corresponding amplitude value for a bin. For example, bin B₀ may include an amplitude value for the velocity profile associated with antenna element 211, an amplitude value for the velocity profile associated with antenna element 212, an amplitude value for the velocity profile associated with antenna element 213, an amplitude value for the velocity profile associated with antenna element 215, an amplitude value for the velocity profile associated with antenna element 216, an amplitude value for the velocity profile associated with antenna element 217, an amplitude value for the velocity profile associated with antenna element 219, an amplitude value for the velocity profile associated with antenna element 220, and an amplitude value for the velocity profile associated with antenna element 221. The peak amplitude for bin B₀ may be selected to represent bin B₀.

The peak values for each of the bins may be used to generate a feature vector that represents the object. For example, an object associated with the velocity profile 400 may be represented as {−B₁₂, −B₁₁, −B₁₀, B₀, . . . B₁₁, B₁₂, B₁₃}. The feature vector associated with an object is an example of a micro-Doppler signature. The feature vector associated with an object may be applied to a machine learning model that is configured to classify the object based on the feature vector.

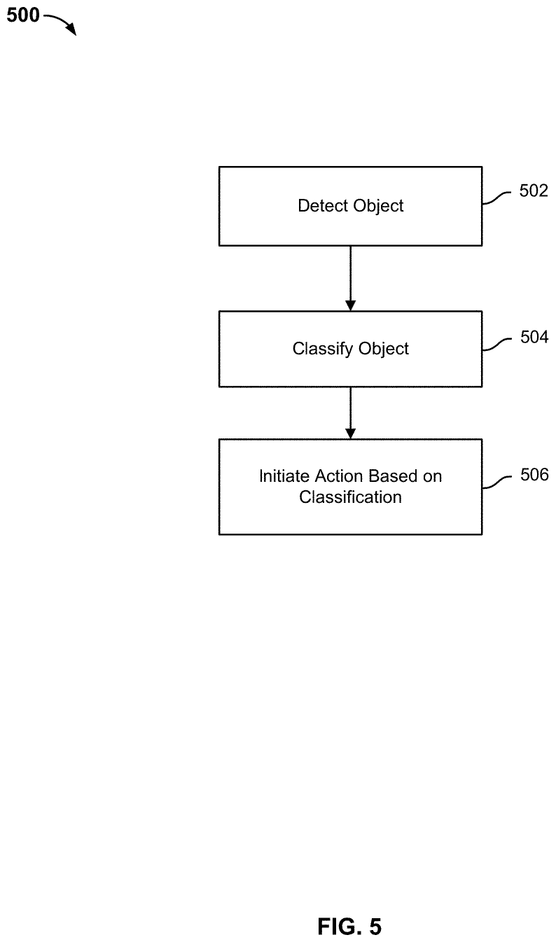

FIG. 5 is a flow chart illustrating an embodiment of a process for capturing a target UAV. In the example shown, process 500 may be performed by a UAV, such as UAV 100.

At 502, an object is detected. A radar system comprising an antenna array may be used to detect an object. The antenna elements of the antenna array may concurrently or individually transmit a signal in a particular direction. In the event there are one or more objects located in the particular direction, the transmitted signals will reflect off the one or more objects. The antenna elements of the antenna array may receive the reflection signals. In some embodiments, a subset of antenna elements receive a reflection signal. The received reflected signal may be used to generate a velocity profile associated with the detected object.

At 504, an object is classified. A feature vector may be generated based on the velocity profile. The feature vector may be applied to a machine learning model that is trained to label an object a UAV or not a UAV based on the feature vector. The feature vector may be applied to a machine learning model that is trained to label the object as a particular type of UAV.

At 506, an action is initiated based on the classification. For example, a capture net launcher may be activated to automatically deploy a capture net when predefined firing conditions are met. One of the predefined firing conditions may include an identification of a target UAV. One of the predefined firing conditions may include a threshold range between the target UAV and UAV. The net fired by the capture net launcher may include a tether connected to a defending UAV to allow the defending UAV to move the target UAV to a safe area for further investigation and/or neutralization.

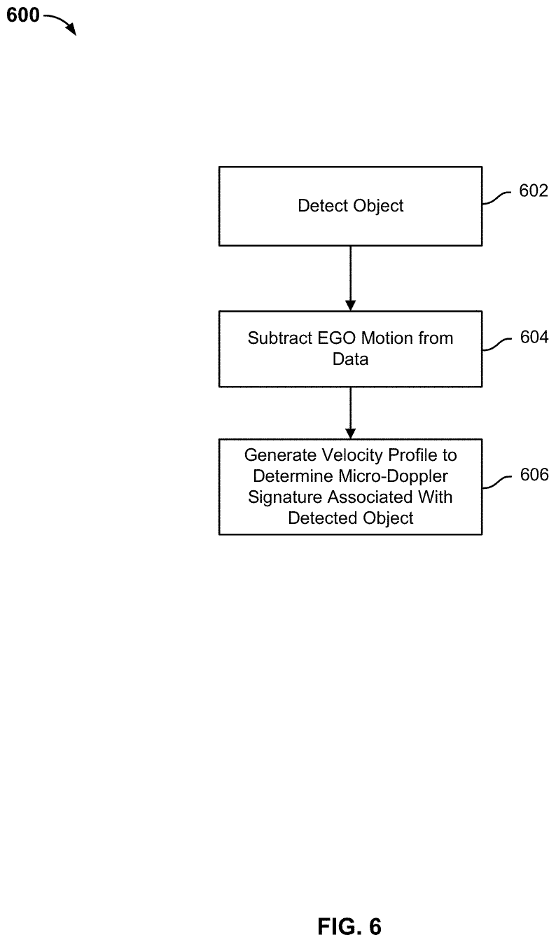

FIG. 6 is a flow chart illustrating an embodiment of a process for determining a micro-Doppler signature associated with a detected object. In the example shown, process 600 may be performed by a radar system, such as radar system 602.

At 602, an object is detected. The object may be initially detected using a 2D MIMO scan. A radar system comprising an antenna array may be used to detect an object. The antenna elements of the antenna array may concurrently transmit a signal in a particular direction. In the event there are one or more objects located in the particular direction, the transmitted signals will reflect off the one or more objects. The antenna elements of the antenna array may receive the reflection signals. In some embodiments, a subset of antenna elements receive a reflection signal.

An antenna array is comprised of a plurality of evenly spaced antenna elements. One problem with phased antenna arrays is spatial aliasing. Spatial aliasing occurs when there is insufficient sampling of the reflection waves along the antenna array. This may occur when the spacing between the antenna elements is not smaller than half the wavelength of the reflection wave. When the antenna elements of the phased antenna array are not spaced apart smaller than half the wavelength of the reflection wave, an antenna element of the phased antenna array may return an artifact (e.g., false positive) and indicate that it detected an object.

When an antenna element indicates that it received a reflection signal, in some embodiments, the antenna element actually received a reflection signal and in other embodiments, the antenna element received an artifact.

The object may be subsequently detected using a 1D MIMO scan. To counteract spatial aliasing, each of the antenna elements of the subset of antenna elements may individually transmit a corresponding signal to detect an object. The corresponding transmission signals may reflect off an object and the reflection signal(s) may be received at one or more antenna elements of the subset of antenna elements. The one or more antenna elements of the subset of antenna elements that received a reflection signal actually received a reflection signal and is not outputting an artifact.

In the event an antenna element detected a reflection signal during the 2D MIMO scan but did not detect a reflection signal during the 1D MIMO scan, the antenna element is determined to have detected an artifact. In the event an antenna element detected a reflection signal during the 2D MIMO scan and detected a reflection signal during the 1D MIMO scan, the antenna element is determined to have detected an object.

At 604, the EGO motion is subtracted from the data associated with the detected object. A UAV may include one or more inertial measurement units (IMUs). The measurements from the one or more IMUs may be used to calculate attitude, angular rates, linear velocity, and/or a position relative to a global reference frame. The radar system of the UAV may receive the measurements from the one or more IMUS and use the measurements to determine an EGO motion of the UAV. The radar system may be configured to subtract out the EGO motion of the UAV from a reflection signal to determine micro-Doppler signature of an object.

At 606, a velocity profile is generated to determine a micro-Doppler signature associated with the detected object. The velocity profile compares the one or more velocities of a reflection signal(s) with an amplitude (strength) of the reflection signal(s). The velocity axis of the velocity profile is comprised of a plurality of bins. A velocity of the reflection signal with the highest amplitude may be identified as a reference velocity and the amplitude associated with the reference velocity may be associated with a reference bin (e.g., bin B₀). The one or more other velocities included in the reflection signal may be compared with respect to the reference velocity. Each bin of the velocity profile represents an offset with respect to the reference velocity. A corresponding bin for the one or more other velocities included in the reflection signal may be determined. A determined bin includes an amplitude associated with one of the one or more other velocities included in the reflection signal. For example, a reflection signal may be a reflection signal associated with a UAV. The UAV is comprised of a main body and a plurality of propellers. The velocity of a UAV body may be represented as a reference velocity in the velocity profile. The velocity of a UAV propeller may be represented in a bin offset from the reference velocity. The bin associated with the reference velocity may store an amplitude associated with the velocity of the UAV body. The bin offset from the reference bin may store an amplitude associated the velocity of a UAV propeller.

A direction of a beam of the phased antenna array may be focused towards a detected object such that a plurality of antenna elements receive a reflection signal from the detected object. The plurality of antenna elements that receive a reflection signal may be adjacent to the antenna element that detected the object during the one dimensional MIMO scan. A velocity profile for each of the received corresponding reflection signals may be generated.

The velocity profile for each of the received corresponding reflection signals may be combined with the velocity profile of the antenna element that detected the object during the one dimensional MIMO scan. The combined velocity profile includes the same bins as one of the velocity profile, but a bin of the combined velocity profile stores a plurality of amplitudes from the plurality of velocity profiles. A maximum amplitude value (peak) may be selected for each bin of the combined velocity profile. The maximum amplitude bin values may be used in a feature vector to classify the object. For example, the feature vector may include the values {Bomar, B imax, . . . , Bᵢᵣ}. The feature vector represents a micro-Doppler signature of the object.

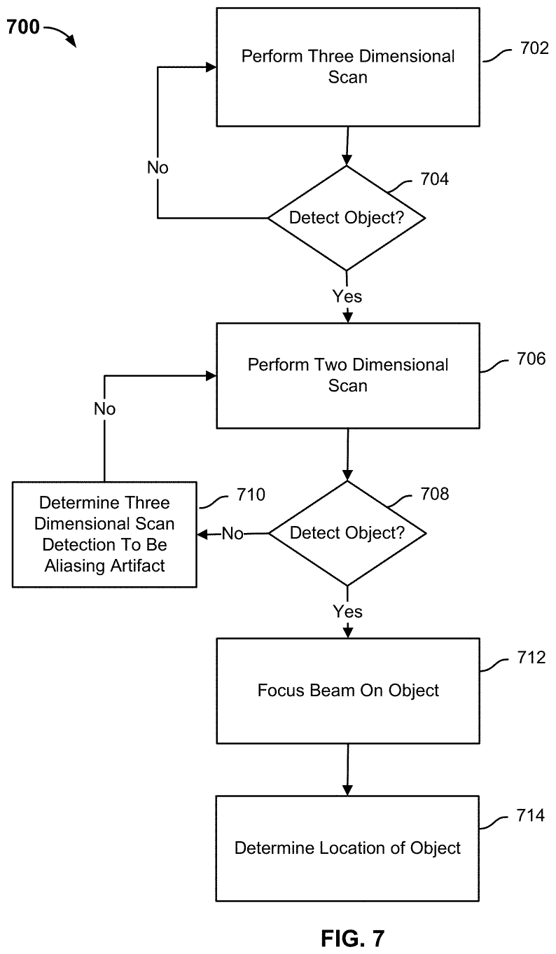

FIG. 7 is a flow chart illustrating an embodiment of a process for detecting an object. In the example shown, process 700 may be performed by a radar system, such as radar system 102. In the example shown, process 700 may be used to perform some or all of steps 502 or 602.

At 702, a three dimensional scan is performed. A 2D MIMO scan may provide three dimensions of information associated with an object (e.g., range, azimuth angle, elevation angle). A radar system comprising an antenna array may be used to detect an object. The antenna elements of the antenna array may concurrently transmit a signal in a particular direction. In the event there are one or more objects located in the particular direction, the transmitted signals will reflect off the one or more objects. In some embodiments, a subset of the antenna elements receives the reflection signal(s). In other embodiments, all of the antenna elements receive the reflection signal(s). In other embodiments, none of the antenna elements receive the reflection signal(s).

An antenna array is comprised of a plurality of evenly spaced antenna elements. One problem with phased antenna arrays is spatial aliasing. Spatial aliasing occurs when there is insufficient sampling of the reflection waves along the antenna array. This may occur when the spacing between the antenna elements is not smaller than half the wavelength of the reflection wave. When the antenna elements of the phased antenna array are not spaced apart smaller than half the wavelength of the reflection wave, an antenna element of the phased antenna array may return an artifact (e.g., false positive) and indicate that it detected an object. When an antenna element indicates that it received a reflection signal, in some embodiments, the antenna element actually received a reflection signal and in other embodiments, the antenna element received an artifact.

At 704, it is determined whether an object is detected. An antenna element of the antenna array may indicate that it received a reflection signal. In the event an object is detected, process 700 proceeds to 706. In the event an object is not detected, process 700 returns to 702.

At 706, a two dimensional scan is performed. A 1D MIMO scan may provide two dimensions of information associated with an object (e.g., range, azimuth angle). To counteract spatial aliasing, each of the antenna elements that detected a reflection signal in 602 may individually transmit a corresponding signal to detect one or more objects. The corresponding transmission signals may reflect off one or more objects and the reflection signal(s) may be received at one or more antenna elements of the subset of antenna elements.

At 708, it is determined whether an object is detected. An object is detected in the event an antenna element transmits a signal and the antenna element receives a reflection signal. In the event an object is detected, process 700 proceeds to 708. In the event the object is not detected process 700 proceeds to 710. At 710, the three dimensional scan detection is determined to be an aliasing artifact. An antenna element may indicate it detected an object during the three dimensional scan, but not indicate that it detected an object during the two dimensional scan. This indicates that the detection was due to an aliasing artifact.

At 712, a beam of the antenna array is focused on the detected object. A direction of a beam of a phased antenna array may be focused towards a detected object such that a plurality of antenna elements receive a reflection signal from the detected object. The plurality of antenna elements that receive a reflection signal may be adjacent to the antenna element that detected the object during a two dimensional scan. A velocity profile for each of the received corresponding reflection signals may be generated. The velocity profile for each of the received corresponding reflection signals may be combined with the velocity profile of the antenna element that detected the object during the one dimensional MIMO scan.

At 714, a location of the object is determined. The three dimensional scan may enable a range associated with an object, an azimuth associated with an object, and an elevation associated with an object to be determined. The two dimensional scan confirms that an antenna element correctly detected an object during the three dimensional scan. A processor may use the information associated with the three dimensional scan to locate the object.

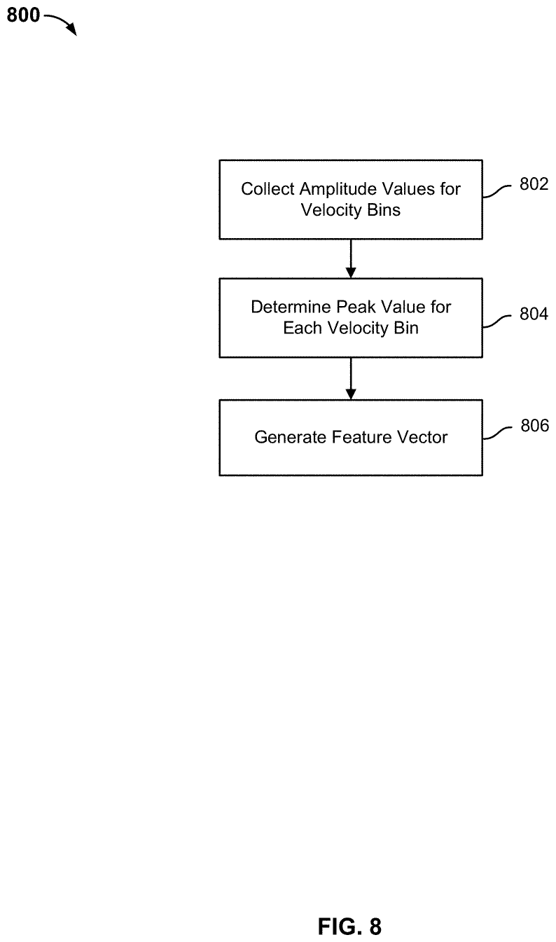

FIG. 8 is a flow chart illustrating an embodiment of a process for generating a micro-Doppler signature associated with an object. In the example shown, process 800 may be performed by a radar system, such as radar system 102.

At 802, a plurality of amplitude values for a velocity bin are collected. A direction of a beam of a phased antenna array may be focused towards a detected object such that a plurality of antenna elements receive a reflection signal from the detected object. The plurality of antenna elements that receive a reflection signal may be adjacent to the antenna element that detected the object during a one dimensional MIMO scan. A velocity profile for each of the received corresponding reflection signals may be generated. The velocity profile for each of the received corresponding reflection signals may be combined with the velocity profile of the antenna element that detected the object during the one dimensional MIMO scan. The combined velocity profile includes the same bins as one of the velocity profile, but a bin of the combined velocity profile stores a plurality of amplitudes from the plurality of velocity profiles. For example, a velocity profile may be generated for antenna elements 211, 212, 213, 215, 216, 217, 219, 220, 221.

At 804, a peak value is determined for each velocity bin. Each of the velocity profiles includes a corresponding amplitude value for a bin. For example, bin B₀ includes an amplitude value for the velocity profile associated with antenna element 211, an amplitude value for the velocity profile associated with antenna element 212, an amplitude value for the velocity profile associated with antenna element 213, an amplitude value for the velocity profile associated with antenna element 215, an amplitude value for the velocity profile associated with antenna element 216, an amplitude value for the velocity profile associated with antenna element 217, an amplitude value for the velocity profile associated with antenna element 219, an amplitude value for the velocity profile associated with antenna element 220, and an amplitude value for the velocity profile associated with antenna element 221. The peak amplitude for bin B₀ may be selected to represent bin B₀.

At 806, a feature vector is generated. The peak values for each of the bins may be used to generate a feature vector that represents the micro-Doppler signature of the detected object. For example, an object associated with the velocity profile 400 may be represented as {−B₁₂, −B₁₁, −B₁₀, . . . , B₀, . . . B₁₁, B₁₂, B₁₃}.

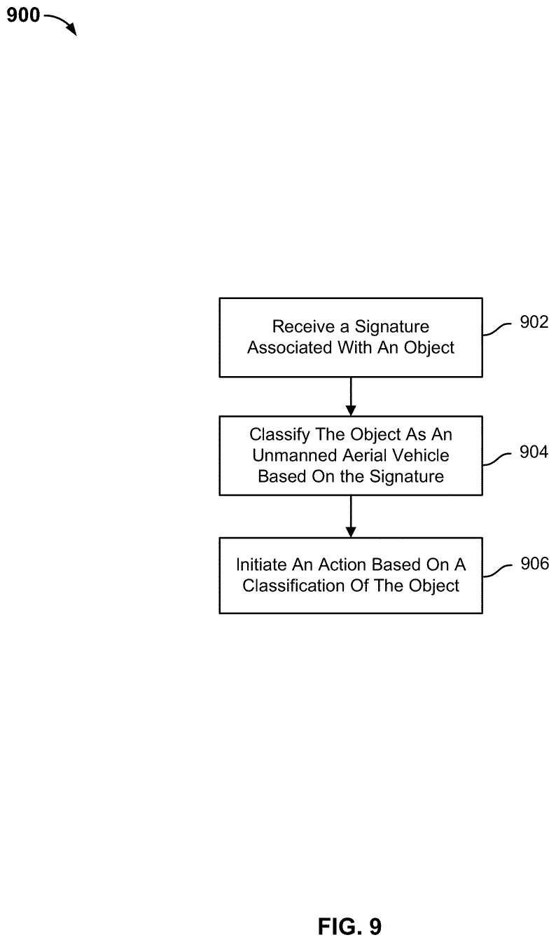

FIG. 9 is a flow chart illustrating an embodiment of a process for capturing a UAV. In the example shown, process 900 may be performed by a UAV, such as UAV 100.

At 902, a signature associated with an object is received. The signature may be a micro-Doppler signature associated with the object that is based on a velocity of the object. The micro-Doppler signature associated with the object may be represented as a feature vector.

At 904, the object is classified based on the signature. The feature vector may be applied to a machine learning model that is trained to determine whether the object is a UAV or not a UAV. The machine learning model may be configured to implement one or more machine learning algorithms (e.g., support vector machine, soft max classifier, autoencoders, naïve bayes, logistic regression, decision trees, random forest, neural network, deep learning, nearest neighbor, etc.). The machine learning model may be trained using a set of training data. The set of training data includes a set of positive examples and a set of negative examples. For example, the set of positive examples may include a plurality of feature vectors that indicate the detected object is a UAV. The set of negative examples may include a plurality of feature vectors that indicate the detected object is not a UAV. For example, the set of negative examples may include feature vectors associated with a balloon, bird, plane, helicopter, etc.

In some embodiments, the output of machine learning model trained to identify UAVs may be provided to one or more other machine learning model that are trained to identify specific UAV models. The velocity profile of a UAV may follow a general micro-Doppler signature, but within the general micro-Doppler signature, different types of UAVs may be associated with different micro-Doppler signatures. For example, the offset difference between a bin corresponding to a baseline velocity and a bin corresponding to a secondary velocity may have a first value for a first UAV and a second value for a second UAV.

At 906, an action is initiated based on a classification of the object. An interdiction system may receive a command to deploy a capture net to capture the UAV. In other embodiments, a jamming signal may be transmitted to the UAV. The interdiction system may include a capture net launcher, one or more sensors, and a control system. The control system may be configured to monitor signals received from the one or more sensors and/or radar system, and control the capture net launcher to automatically deploy the capture net when predefined firing conditions are met. One of the predefined firing conditions may include an identification of a target UAV. One of the predefined firing conditions may include a threshold range between the target UAV and UAV. The one or more sensors may include a global positioning system, a light detection and ranging (LIDAR) system, a sounded navigation and ranging (SONAR) system, an image detection system (e.g., photo capture, video capture, UV capture, IR capture, etc.), sound detectors, one or more rangefinders, etc. The net fired by the capture net launcher may include a tether connected to a defending UAV to allow the defending UAV to move the target UAV to a safe area for further investigation and/or neutralization.

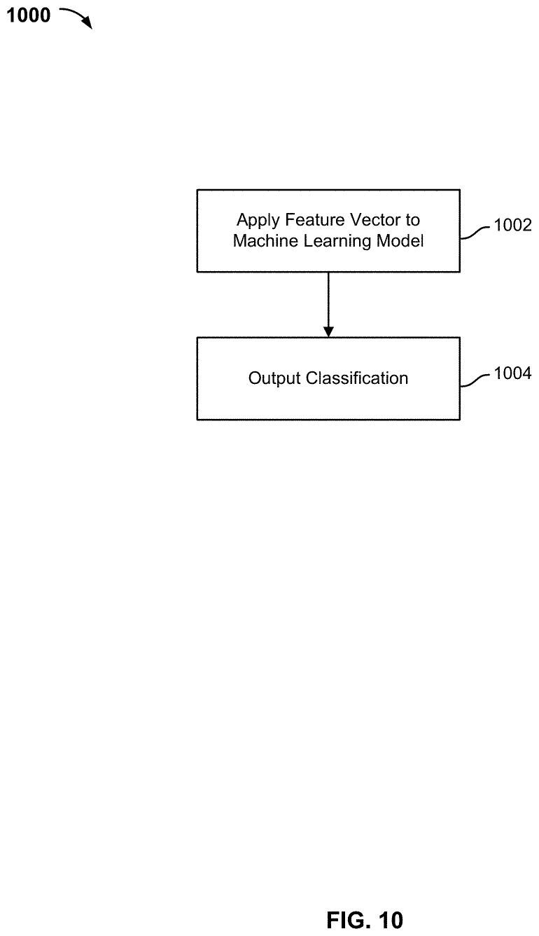

FIG. 10 is a flow chart illustrating an embodiment of a process for classifying an object. In the example shown, process 1000 may be performed by a UAV, such as UAV 100.

At 1002, a feature vector is applied to a machine learning model. The feature vector may represent a micro-Doppler signature associated with an object. Each value of the feature value may correspond to a bin of a velocity profile associated with the object. The value may represent an amplitude of a velocity for a bin. In some embodiments, the value represents a peak value for a bin. For example, an object associated with the velocity profile 400 may be represented as {−B₁₂, −B₁₁, −B₁₀, . . . , B₀, . . . B₁₁, B₁₂, B₁₃}.

The machine learning model may be a support vector machine. The machine learning model may be a soft max classifier. The machine learning model may be trained to detect UAVs and use the feature vector to output a label indicating whether the object is a UAV or not a UAV. The machine learning label may include other classifiers trained to classify other objects.

In some embodiments, the feature vector is applied to a hierarchical classifier. A first level of the hierarchical classifier includes a machine learning model that is trained to output a label indicating whether the object is or is not a UAV. In the event the first level of the hierarchical classifier outputs a label indicating the object is a UAV, the label along with the feature vector may be provided to a second level of the hierarchical classifier. The second level may be comprised of a one or more machine learning models. Each machine learning model of the second level may be trained to output a label indicating whether the object is a particular type of UAV. For example, a first machine learning model of the second level may be trained to output a label indicating whether the object is or is not a first type of UAV based on the feature vector associated with the object. A second machine learning model of the second level may be trained to output a label indicating whether the object is or is not a second type of UAV based on the feature vector associated with the object.

At 1004, a classification is output. The classification is provided a processor of the UAV. An action may be performed based on the classification. For example, the classifier may classify the object as a UAV. In response to the object being classified as a UAV, an interdiction system may be activated to capture the UAV. In other embodiments, the classifier may classify the object as not-a-UAV. For example, the object may be a balloon, a bird, or an airplane. In response to object not being classified as a UAV, the defending UAV may not activate the interdiction system and continue to search for a UAV.

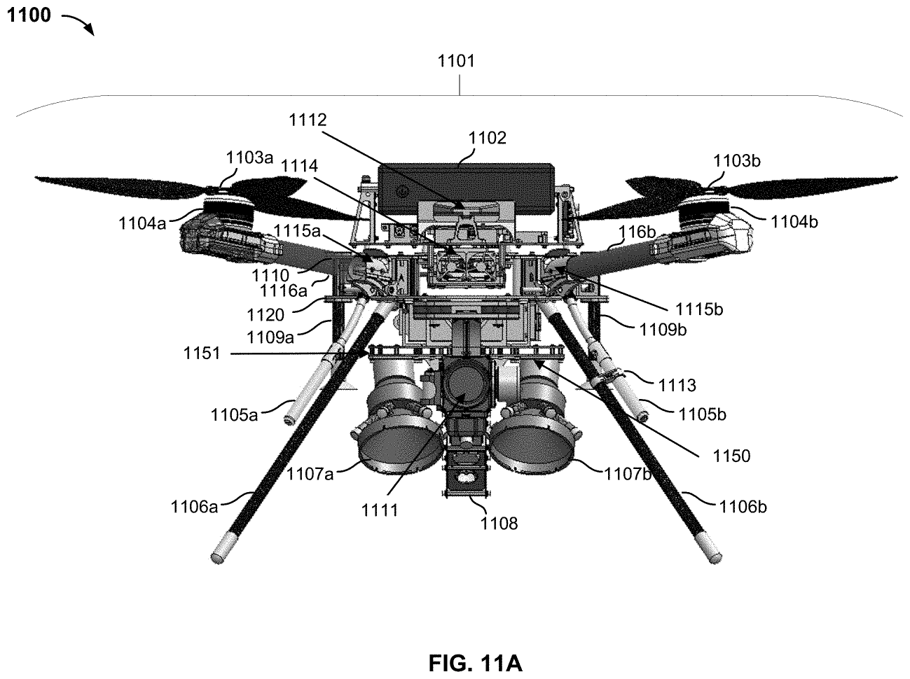

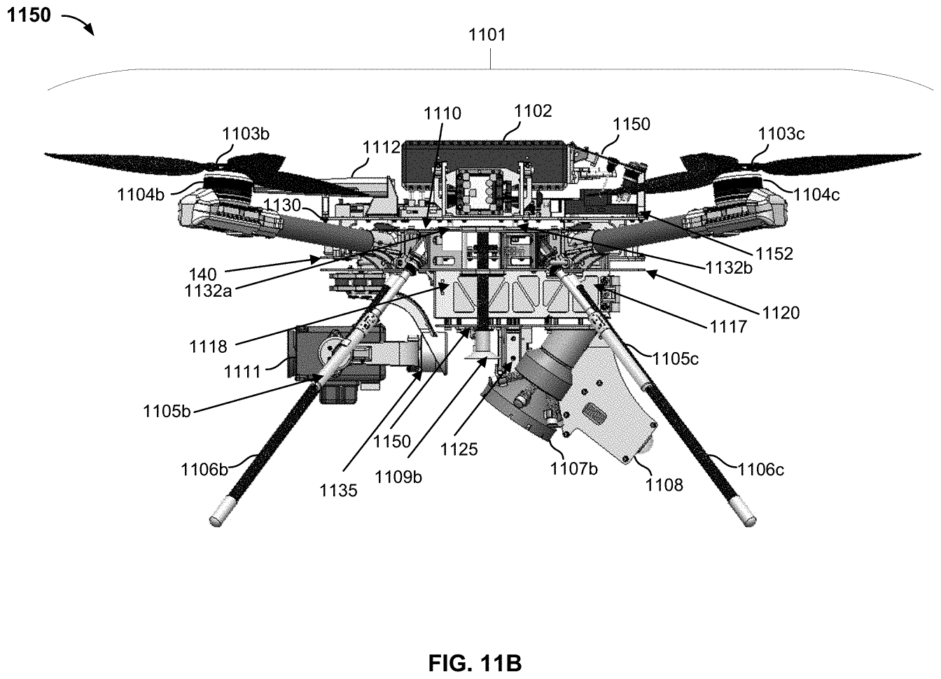

FIG. 11A is a diagram illustrating a front view of a UAV in accordance with some embodiments. In some embodiments, unmanned aerial vehicle 1100 may be used to implement a UAV, such as UAV 100.

In the example shown, front view 1100 includes unmanned aerial vehicle 1101 comprising computing chassis 1102, first rotor 1103a, second rotor 1103b, first motor 1104a, second motor 1104b, first antenna 1105a, second antenna 1105b, first landing strut 1106a, second landing strut 1106b, first net launcher 1107a, second net launcher 1107b, first guide collar 1109a, second guide collar 1109b, interdiction sensor module 1108, first structural isolation plate 1110, visual detection system 1111, disruption signal antenna 1112, antenna clip 1113, one or more cooling fans 1114, first rotor arm bracket 1115a, second rotor arm bracket 1115b, first rotor arm 1116a, second rotor arm 1116b, second structural isolation plate 1120, vibration isolation plate 1130, vibration isolation plate 1140, vibration isolation plate 1150, and dampers 1151.

Computing chassis 1102 is configured to protect the CPU of UAV 1101. The CPU is configured to control the overall operation of UAV 1101. The CPU may be coupled to a plurality of computing modules. For example, the plurality of computing modules may include an interdiction control module, an image processing module, a safety module, a flight recorder module, etc. The CPU may provide one or more control signals to each of the plurality of computing modules. For example, the CPU may provide a control signal to the interdiction control module to activate one of the net launchers 1107a, 1107b to deploy a net. The CPU may provide a control signal to the image processing module to process an image captured by the visual detection system 1111. The CPU may be configured to perform one or more flight decisions for the UAV. For example, the CPU may provide one or more flights commands to a flight controller module. For example, a flight command may include a specified speed for the UAV, a specified flight height for the UAV, a particular flight path for the UAV, etc. In response to the one or more flight commands, the flight controller module is configured to control the motors associated with the UAV (e.g., motors 1104a, 1104b) so that UAV 101 flies in a manner that is consistent with the flight commands. In some embodiments, the CPU is configured to receive flight instructions from a remote command center. In other embodiments, the CPU is configured to autonomously fly UAV 1101.

The image processing module is configured to process images acquired by visual detection system 1111. The image processing module may be configured to determine whether a visually detected object is a UAV based on the visual data associated with the detected object. The image processing module may include a plurality of machine learning models that are trained to label a detected object based on the visual data. For example, the image processing module may include a first machine learning model that is configured to label objects as a UAV, a second machine learning model that is configured to label objects as a bird, a third machine learning model that is configured to label objects as a plane, etc.

First structural isolation plate 1110 is configured to isolate computing chassis 1102 and its associated computing components from one or more noisy components. First structural isolation plate 1110 is also configured to isolate the one or more noisy components from the electromagnetic interference noise associated with the computing components of computing chassis 1102. The one or more noisy components isolated from computing chassis 1102 and its associated computing components by first structural isolation plate 1110 may include may include a communications radio (not shown in the front view) and a communications disruption signal generator (not shown in the front view).

First structural isolation plate 1110 may include a foil made from a particular metallic material (e.g., copper) and the foil may have a particular thickness (e.g., 0.1 mm). First structural isolation plate 1110 and second structural isolation plate 1120 may act as a structural frame for UAV 1101. First structural isolation plate 1110 may be coupled to second structural isolation plate 1120 via a plurality of rotor arm brackets (e.g., rotor arm brackets 1115a, 1115b) and a plurality of side wall components (not shown in the front view). The rotor arm brackets are coupled to a corresponding rotor arm. The first structural isolation plate 1110 may be attached to one or more rotor arm clips (not shown in the front view). The one or more rotor arm clips are configured to lock and unlock corresponding rotor arms of UAV 1101. The one or more rotor arm clips are configured to lock the rotor arms in a flight position when UAV 1101 is flying. The one or more rotor arm clips are configured to unlock the rotor arms from a flight position when UAV 1101 is not flying. For example, the rotor arms may be unlocked from the rotor arm clips when UAV 1101 is being stored or transported to different locations.

First structural isolation plate 1110 is coupled to vibration isolation plate 1130 via a plurality of vibration dampers. First structural isolation plate 1110 may be coupled to one or more dampers configured to reduce the amount of vibration to which a plurality of vibration sensitive components are subjected. The plurality of vibration sensitive components may include the computing modules included in computing chassis 1102, connectors, and heat sinks. The performance of the vibration sensitive components may degrade when subjected to vibrations. The one or more dampers may be omnidirectional dampers. The one or more dampers may be tuned to the specific frequency associated with a vibration source. The vibrations may be mechanical vibrations caused by the motors of the UAV (e.g., motors 1104a, 1104b) and the rotors of the UAV (e.g., rotors 1103a, 1103b). First structural isolation plate 1110 in combination with vibration isolation plate 1130 and the plurality of dampers are configured to shield the plurality of computing components from vibrations, noise, and EMI.

Vibration isolation plate 1130 is coupled to antenna 1112 associated with a communications disruption signal generator. Antenna 1112 may be a highly directional antenna (e.g., log periodic, parabolic, helical, yagi, phased array, horn, etc.) that is configured to transmit a communications disruption signal. The communications disruption signal may have a frequency associated with one or more wireless communications devices that the communications disruption signal is attempting to disrupt. For example, the communications disruption signal may have a frequency between 2.1 GHz and 5.8 GHz.

UAV 1101 includes second structural isolation plate 1120. A UAV may also be designed to include an isolation plate to isolate the noisy components from the radiating components and vice versa. Second structural isolation plate 1120 is configured to isolate the one or more noisy components from one or more antennas and one or more sensors and vice versa. Second structural isolation plate 1120 is also configured to act as a ground plane for the one or more antennas associated with a radio communications system of UAV 1101.

Structural isolation plate 1120 may also be coupled to one or more dampers to reduce an amount of vibration to which the noisy components are subjected. The combination of structural isolation plate 1110 and structural isolation plate 1120 act as a Faraday cage for the noisy components. The combination of structural isolation plate 1110 and structural isolation plate 1120 are configured to isolate one or more high noise generating components of the UAV from the other components of the UAV. For example, a radio communications system and a communication disruption signal generator may be isolated from a plurality of computing components and a plurality of antennas. As a result, the influence that vibrations, noise, and EMI have on the overall performance of the UAV is reduced. One or more cooling fans 1114 are coupled to and may be positioned in between vibration isolation plate 1130 and vibration isolation plate 1140. The high noise generating components of the UAV may generate a lot of heat during operation. One or more cooling fans 1114 are configured to direct air towards the high noise generating components such that a temperature of the high noise generating components of the UAV is reduced during operation. A portion of the one or more cooling fans 1114 may be placed adjacent to one of the openings of the structural frame comprising first structural isolation plate 1110 and second structural isolation plate 1120.

First rotor arm bracket 1115a is coupled to first rotor arm 1116a and second rotor arm bracket 1116a is coupled to second rotor arm 1116b. First rotor arm 1116a is coupled to motor 1104a and rotor 1103a. Second rotor arm 1116b is coupled to motor 1104b and rotor 1103b. Rotor arm brackets 1115a, 1115b are configured to engage rotor arms 1116a, 1116b, respectively. UAV 1101 may lift off from a launch location and fly when rotor arms 1116a, 1116b are engaged with their corresponding rotor arm brackets 1115a, 1115b. When rotor arms 1116a, 1116b are engaged with their corresponding rotor arm brackets 1115a, 1115b, motors 1104a, 1104b may provide a control signal to rotors 1103a, 1103b to rotate.

A radio communications system of UAV 1101 may be associated with a plurality of antennas (e.g., antenna 1105a, antenna 1105b). Each antenna may operate at a different frequency. This enables the radio communications system to switch between frequency channels to communicate. The radio communications system may communicate with a remote server via antenna 1105a. For example, the radio communications system may transmit the data associated with the one or more sensors associated with UAV 1101 (e.g., radar data, lidar data, sonar data, image data, etc.). The frequency channel associated with antenna 1105a may become noisy. In response to the frequency channel associated with antenna 1105a becoming noisy, the radio communications system may switch to a frequency channel associated with antenna 1105b. The antennas associated with the radio communications system may be daisy chained together. The persistent systems radio may communicate with one or more other UAVs and transmit via antennas 1105a, 1105b, a signal back to a source through the one or more other UAVs. For example, another UAV may act as an intermediary between UAV 1101 and a remote server. UAV 1101 may be out of range from the remote server to communicate using antennas 1105a, 1105b, but another UAV may in range to communicate with UAV 1101 and in range to communicate with the remote sever. UAV 1101 may transmit the data associated with one or more sensors to the other UAV, which may forward the data associated with one or more sensors to the remote server.

The radio communications system of UAV 1101 may be associated with three antennas (e.g., antenna 1105a, antenna 1105b, antenna 1105c). The antennas may be approximately 90 degrees apart from each other (e.g., 90°±5°). The antennas may be coupled to the landing struts of UAV 1101 (e.g., landing strut 1106a, landing strut 1106b, landing strut 1106c) via an antenna clip, such as antenna clip 1113. This allows the antennas to have a tripod configuration, which allows the antennas to have enough fidelity to transmit the needed bandwidth of data. For example, the tripod configuration allows the antennas to have sufficient bandwidth to transmit video data or any other data obtained from the one or more sensors of UAV 1101.

UAV 1101 may include a fourth antenna (not shown) that is also coupled to one of the landing struts of UAV 1101. UAV 1101 may be remotely controlled and the fourth antenna may be used for remote control communications. In some embodiments, the antennas coupled to the landing struts of UAV 1101 may be integrated into the landing strut, such that an antenna is embedded within a landing strut.

UAV 1101 may include guide collars 1109a, 1109b. Guide collars 1109a, 1109b may be coupled to a plurality of launch rails. UAV 1101 may be stored in a hangar that includes the plurality of launch rails. Guide collars 1109a, 1109b are hollow and may be configured to slide along the launch rails to constrain lateral movement of UAV 1101 until it has exited the housing or hangar.

UAV 1101 may include a vibration plate 1150 that is coupled to a battery cage via a plurality of dampers 1151. The vibration plate 1150 may be coupled to net launchers 1107a, 1107b and interdiction sensor system 1108. Interdiction sensor system 1108 may include at least one of a global positioning system, a radio detection and ranging (RADAR) system, a light detection and ranging (LIDAR) system, a sounded navigation and ranging (SONAR) system, an image detection system (e.g., photo capture, video capture, UV capture, IR capture, etc.), sound detectors, one or more rangefinders, etc. For example, eight LIDAR or RADAR beams may be used in the rangefinder to detect proximity to the target UAV. Interdiction sensor system 1108 may include one or more LEDs that indicate to bystanders whether UAV 1101 is armed and/or has detected a target. The one or more LEDs may be facing away from the back of UAV 1101 and below UAV 1101. This enables one or more bystanders under UAV 1101 to become aware of a status associated with UAV 1101.

Interdiction sensor system 1108 may include image capture sensors which may be controlled by the interdiction control module to capture images of the object when detected by the range finding sensors. Based on the captured image and the range readings from the ranging sensors, the interdiction control module may identify whether or not the object is a UAV and whether the UAV is a UAV detected by one of the sensor systems.

When the interdiction control module determines that the object is a target UAV, it may also determine if the target UAV is an optimal capture position relative to the defending UAV. The position between UAV 1101 and the target UAV may be determined based on one or more measurements performed by interdiction sensor system 1108. If the relative position between the target UAV and the defending UAV is not optimal, interdiction control module may provide a recommendation or indication to the remote controller of the UAV. An interdiction control module may provide or suggest course corrections directly to the flight controller module to maneuver UAV 1101 into an ideal interception position autonomously or semi-autonomously. Once the ideal relative position between the target UAV and the defending UAV is achieved, the interdiction control module may automatically trigger one of the net launchers 1107a, 1107b. Once triggered, one of the net launchers 1107a, 1107b may fire a net designed to ensnare the target UAV and disable its further flight.

The net fired by the capture net launcher may include a tether connected to UAV 1101 to allow UAV 1101 to move the target UAV to a safe area for further investigation and/or neutralization. The tether may be connected to the defending UAV by a retractable servo controlled by the interdiction control module such that the tether may be released based on a control signal from the interdiction control module. The CPU of the UAV may be configured to sense the weight, mass, or inertia effect of a target UAV being tethered in the capture net and recommend action to prevent the tethered target UAV from causing UAV 1101 to crash or lose maneuverability. For example, the CPU may recommend UAV 1101 to land, release the tether, or increase thrust. The CPU may provide a control signal to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

UAV 1101 may include visual detection system 1111. Visual detection system 1111 may include one or more cameras. Visual detection system 1111 may be used by a remote operator to control a flight path associated with UAV 1101. Visual detection system 1111 may provide visual data to an image processing module configured to visually detect an object and provide visual data (e.g., pixel data) to one or more machine learning models. The one or more machine learning models may be trained to label an object as a UAV based on the visual data. The image processing module may provide an output indicating that an object is labeled as a UAV to the interdiction control module. The interdiction control module may be configured to activate net launchers 1107a, 1107b based on the label. For example, in the event the visually detected object is labeled a UAV and the visually detected object is within a threshold range from UAV 1101, the interdiction control module may output a control signal that causes one of the net launchers 1107a, 1107b to deploy a net.

FIG. 11B is a diagram illustrating a side view of a UAV in accordance with some embodiments. In some embodiments, unmanned aerial vehicle 1100 may be used to implement a UAV, such as UAV 100.

In the example shown, side view 1150 includes unmanned aerial vehicle 1101 comprising computing chassis 1102, UI panel 1150, flight controller module 1152, second rotor 1103b, third rotor 1103c, second motor 1104b, third motor 1104c, second antenna 1105b, third antenna 1105c, second landing strut 1106b, third landing strut 1106c, battery 1117, battery cage 1118, second net launcher 1107b, interdiction sensor module 1108, second guide collar 1109b, first structural isolation plate 1110, visual detection system 1111, disruption signal antenna 1112, antenna clip 1113, second structural isolation plate 1120, gimbal 1135, tether mechanism 1125, vibration dampers 1132a, 1132b, vibration isolation plate 1140, and vibration isolation plate 1150.

UI panel 1150 is coupled a safety module that is included in computing chassis 1102. UI panel 1150 comprises one or more switches, knobs, buttons that enables an operator to arm and disarm UAV 1101. An operator may interact with UI panel 1150 and based on the operator interactions, the safety module is configured to arm/disarm UAV 1101. For example, first net launcher 1107a and second net launcher 1107b may be disarmed based on one or more interactions of an operator with UI panel 1150. This may allow the operator to inspect and/or perform maintenance on UAV 1101.

Flight controller module 1152 is configured to control a flight of UAV 1101. The flight controller module may provide one or more control signals to the one or more motors (e.g., 1104a, 1104b) associated with UAV 1101. The one or more control signals may cause a motor to increase or decrease its associated revolutions per minute (RPM). UAV 1101 may be remotely controlled from a remote location. UAV 1101 may include an antenna that receives flight control signals from the remote location. In response to receiving the flight control signals, the CPU of UAV 1101 may determine how UAV 1101 should fly and provide control signals to flight controller module 1152. In response to the control signals, flight control 1152 is configured to provide control signals to the one or more motors associated with UAV 1101, causing UAV 1101 to maneuver as desired by an operator at the remote location.

Antenna 1105c is coupled to landing strut 1106c. Antenna 1105c is one of the antennas associated with a communications radio system of UAV 1101. Antenna 1105c is configured to operate at a frequency that is different than antennas 1105a, 1105b. A communications radio system may be configured to switch between frequency channels to communicate. The communications radio system may communicate with a remote server via antenna 1105a. The frequency channel associated with antenna 1105a may become noisy. For example, the radio communications system may transmit the data associated with the one or more sensors associated with UAV 1101 (e.g., radar data, lidar data, sonar data, image data, etc.). In response to the frequency channel associated with antenna 1105a becoming noisy, the radio communications system may switch to a frequency channel associated with antenna 1105b. The frequency channel associated with antenna 1105b may become noisy. In response to the frequency channel associated with antenna 1105b becoming noisy, the radio communications system may switch to a frequency channel associated with antenna 1105c.

Battery 1117 is configured to provide power to UAV 1101. UAV 1101 is comprised of a plurality of components that require electricity to operate. Battery 1117 is configured to provide power to the plurality of components. In some embodiments, battery 1117 is a rechargeable battery. Battery 1117 is housed within battery cage 1118. Battery cage 1118 may be coupled to vibration isolation plate 1150 via a plurality of dampers. Vibration isolation plate 1150 may be coupled to interdiction sensor module 1108, net launchers 1107a, 1107b, tether mechanism 1125, and a persistent availability plug.

Gimbal 1135 is coupled to visual detection system 1111 and second structural isolation plate 1120. A gimbal is a pivoted support that allows the rotation of visual detection system 1111 about a single axis. Gimbal 1135 is configured to stabilize an image captured by visual detection system 1111.

Tether mechanism 1135 is coupled to net capture launchers 1107a, 1107b. When a net is deployed by one of the net capture launchers 1107a, 1107b, the net remains tethered to UAV 1101 via tether mechanism 1125. Tether mechanism 1125 may be configured to sense the weight, mass, or inertia effect of a target UAV being tethered in the capture net. In response to the sensed signals, a CPU of UAV 1101 may be configured to recommend action to prevent the tethered target UAV from causing UAV 1101 to crash or lose maneuverability. For example, the CPU of UAV 1101 may recommend UAV 1101 to land, release the tether, or increase thrust. The CPU of UAV 1101 may provide a control signal to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

Vibration dampers 1132a, 1132b are coupled to structural isolation plate 1110 and vibration isolation plate 1130. Vibration dampers 1132a, 1132b may be omnidirectional dampers. Vibration dampers 1132a, 1132b may be configured to reduce the amount of vibration to which a plurality of vibration sensitive components are subjected. The plurality of vibration sensitive components may include different electronics modules (e.g., components included in computing chassis 1102, connectors, and heat sinks. The performance of the vibration sensitive components may degrade when subjected to vibrations. Vibration dampers 1132a, 1132b may be tuned to the specific frequency associated with a vibration source. The vibrations may be mechanical vibrations caused by the motors of the UAV (e.g., motors 1104a, 1104b) and the rotors of the UAV (e.g., rotors 1103a, 1103b). Vibration damper 1132a, 1132b may be tuned to the mechanical vibrations caused by the motors of the UAV and the rotors of the UAV. Vibration dampers 1132a, 1132b may be comprised of a vibration damping material, such as carbon fiber. In some embodiments, one or more vibration dampers may be included in between a motor and a motor mount.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An aerial vehicle system, comprising:
a radar system configured to:
transmit a radar signal, wherein the transmitted radar signal is reflected off an object to produce a reflected radar signal;
receive the reflected radar signal; and
provide a signature associated with the reflected radar signal, wherein the signature has been adjusted based at least in part on a flight parameter of the aerial vehicle system; and
a processor configured to:
classify the object as an unmanned aerial vehicle based on the adjusted signature; and
initiate an action based on a classification of the object.

2. The aerial vehicle system of claim 1, wherein the radar system is comprised of a plurality of antennas, wherein the plurality of antennas are configured to transmit the radar signal, wherein a subset of the plurality of antennas are configured to receive the reflected radar signal, wherein the radar system is configured to transmit the radar signal and receive the reflected signal as part of a three-dimensional radar scan.

3. The aerial vehicle system of claim 2, wherein for the subset of the plurality of antennas that receive the reflected radar signal, the radar system is configured to perform a two-dimensional radar scan.

4. The aerial vehicle system of claim 3, wherein at least one antenna of the subset of the plurality of antennas detects the object during the two-dimensional scan.

5. The aerial vehicle system of claim 4, wherein the radar system is further configured to cause a radar beam associated with the plurality of antennas to focus on the object detected during the two-dimensional scan.

6. The aerial vehicle system of claim 5, wherein the radar system is further configured to generate one or more velocity profiles for the objected detected during the two-dimensional scan.

7. The aerial vehicle system of claim 6, wherein a feature vector is generated based on the one or more velocity profiles.

8. The aerial vehicle system of claim 7, wherein the feature vector is the signature associated with the reflected signal.

9. The aerial vehicle system of claim 3, wherein at least one antenna of the subset of the plurality of antennas receives the reflected radar signal during the three-dimensional radar scan and does not detect the object during the two-dimensional scan.

10. The aerial vehicle system of claim 1, wherein the object is classified as an unmanned aerial vehicle using a machine learning model.

11. The aerial vehicle system of claim 10, wherein the machine learning model is configured to determine a particular type of the unmanned aerial vehicle based on the signature.

12. The aerial vehicle system of claim 10, wherein the machine learning model is configured to implement at least one of support vector machine, soft max classifier, autoencoders, naïve bayes, logistic regression, decision trees, random forest, neural network, deep learning, and/or nearest neighbor.

13. The aerial vehicle system of claim 1, wherein the radar system is configured to:
receive one or more measurements from one or more inertial measurement units;
use the one or more received measurements to adjust the signature associated with the reflected signal.

14. The aerial vehicle system of claim 13, wherein the one or more received measurements are used to remove an EGO motion of the aerial vehicle system from the reflection radar signal.

15. The aerial vehicle system of claim 1, wherein the action includes activating a capture mechanism based on one or more firing conditions.

16. The aerial vehicle system of claim 15, wherein one of the one or more firing conditions includes a range between the aerial vehicle system and the unmanned aerial vehicle being less than a threshold distance.

17. The aerial vehicle system of claim 15, wherein one of the one or more firing conditions includes the object being classified as the unmanned aerial vehicle.

18. The aerial vehicle system of claim 15, wherein the capture mechanism includes a net.

19. A method, comprising:
transmitting a radar signal, wherein the transmitted radar signal is reflected off an object to produce a reflected radar signal;
receiving the reflected radar signal; and
determining a signature associated with the reflected radar signal, wherein the signature has been adjusted based at least in part on a flight parameter of the aerial vehicle system; and
classifying the object as an unmanned aerial vehicle based on the adjusted signature; and
initiating an action based on a classification of the object.

20. A computer program product, the computer program product being embodied on a non-transitory computer readable storage medium and comprising instructions for:
transmitting a radar signal, wherein the transmitted radar signal is reflected off an object to produce a reflected radar signal;
receiving the reflected radar signal; and
determining a signature associated with the reflected radar signal, wherein the signature has been adjusted based at least in part on a flight parameter of the aerial vehicle system; and
classifying the object as an unmanned aerial vehicle based on the adjusted signature; and
initiating an action based on a classification of the object.
